(19) United States
(12) Patent Application Publication
(10) Pub. No.: US 2013/0047754 A1
(43) Pub. Date: Feb. 28, 2013

(54) MECHANICAL ADVANTAGE MACHINE

(71) Applicant: Milan Condric, Palm Beach Gardens, FL (US)

(72) Inventor: Milan Condric, Palm Beach Gardens, FL (US)

(21) Appl. No.: 13/217,615

(22) Filed: Aug. 25, 2011

(51) Int. Cl. F03G 3/00; F03G 7/10

(52) U.S. Cl. 74/61; 74/DIG. 9

(57) ABSTRACT

A mechanical advantage machine is provided. The mechanical advantage machine may comprise an elliptical track, a mobile weight, and a fulcrum point disposed at a vertex of the elliptical track. The mechanical advantage machine may further include at least one actuation rod coupled to at least one cam, wherein the traversal of the mobile weight about the circumference of the elliptical track causes the track to move causing the actuation rod to move which in turn causes the cam to rotate. A method for generating power may also be provided. The method may include mobilizing a weight about a circumference of an elliptical track comprising a fulcrum point disposed at a vertex of the circumference of the elliptical track, the mobilization pivoting the elliptical track in response to the weight traversing the elliptical track while at least one actuation rod causes the rotation of at least one cam.

### BACKGROUND OF THE INVENTION

1. Field of the Invention

The present invention relates to power generation and more particularly power generation created by mechanical movements.

2. Description of the Related Art

Man first started using machines to make work easier and faster. The mechanical advantage of a machine is how much easier and faster a machine makes your work. In science terms, the mechanical advantage (MA) is the number of times a machine multiplies your effort force. Generally, mechanical advantage is defined as:

MA=output force/input force

There are two types of mechanical advantage: ideal mechanical advantage (IMA) and actual mechanical advantage (AMA). Ideal mechanical advantage (or theoretical mechanical advantage) is the mechanical advantage of an ideal machine. An ideal machine is an idealistic system in which there is no loss of energy. In other words, an ideal machine is one where there is no transfer of energy from the machine to another object; thus, the amount of force that the machine exerts of an object is equivalent to the input force. IMA is determined by dividing the effort distance by the resistance distance. Currently, no ideal machine actually exists, but its use aids in thought and analysis and can allow adequate approximations. Actual mechanical advantage is the mechanical advantage of a real machine; AMA takes into consideration real world factors such as energy lost due to friction or radiation. AMA is calculated by dividing the resistance force obtained from the machine by the actual effort force applied to the machine.

Previous attempts at generating power using mechanical advantage have been unsuccessful; the failure occurs because not enough power is generated or the machine is limited as to where it can be installed. For example, a power generator machine requiring horses to move weights would be an impracticable power source for a large ship. In addition, current forms of power generation can also be expensive to build, to maintain, and to operate.

### BRIEF SUMMARY OF THE INVENTION

Embodiments of the present invention address deficiencies of the art in respect to power generation and provide a novel and non-obvious apparatus for power generation created upon the movement of a mobile weight via mechanical advantage. In an embodiment of the invention, an apparatus having an elliptical track, a mobile weight traversing a circumference of the elliptical track, and a fulcrum point disposed at a vertex of the circumstance of the elliptical track can be provided. The mechanical advantage machine can further include at least one actuation rod coupled to at least one cam at one end of the rod and coupled to the elliptical track at an opposite end of the rod. Of note, the traversal of the mobile weight about the circumference of the elliptical track causes a portion of the elliptical track below the mobile weight to move downwardly in response to the mobile weight while concurrently an opposite portion of the elliptical track defined by the vertex moves upwardly, a repeated downward and upward movement of the elliptical track causing the actuation rod to move which in turn causes the cam to rotate.

A method for power generation can also be provided. The method may include mobilizing a weight about a circumference of an elliptical track comprising a fulcrum point disposed at a vertex of the circumference of the elliptical track, the mobilization pivoting the elliptical track at the fulcrum point in response to the weight traversing the elliptical track, while at least one actuation rod coupled to at least one cam at one end and coupled to the elliptical track as an opposite end of the actuation rod moves responsively to the mobilization as one portion of the elliptical track moves downwardly in response to the weight passing above the one portion, while concurrently a portion of elliptical track opposite the one portion across the fulcrum point moves upwardly, where the movement of the actuation rod causes the rotation of the cam.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a front view of a mechanical advantage machine with an elliptical track positioned with a left-side tilt configured with a cart;

FIG. 2 is a cut-away view of a mechanical advantage machine without the cart;

FIG. 3 is a view of a mechanical advantage machine with an elliptical track having a right-side tilt;

FIG. 4 is a plan view of an elliptical track with a rotating weight;

FIG. 5 is a view of the power transfer system in an embodiment of a mechanical advantage machine;

FIG. 6 is a view of the cart in an embodiment of a mechanical advantage machine; and,

FIG. 7 illustrates a power transfer ball assembly in an embodiment of a mechanical advantage machine.

### DETAILED DESCRIPTION OF THE INVENTION

In accordance with an embodiment of the invention, a mechanical advantage machine can be provided. The machine can include a mobile weight traversing a circumference of an elliptical track. The machine can further include a fulcrum point disposed at a vertex of the circumference of the elliptical track. As the weight travels around the track, different portions of the track move downwardly in response to the weight, which can cause at least one actuation rod coupled to at least cam to rotate, which can be used to generate power. Of note, the power generated is inexpensive to produce. Of further note, the mechanical advantage machine can be built to a variety of different sizes to accommodate the amount of power production desired which enables the machine to have the flexibility of being located in a variety of different locations.

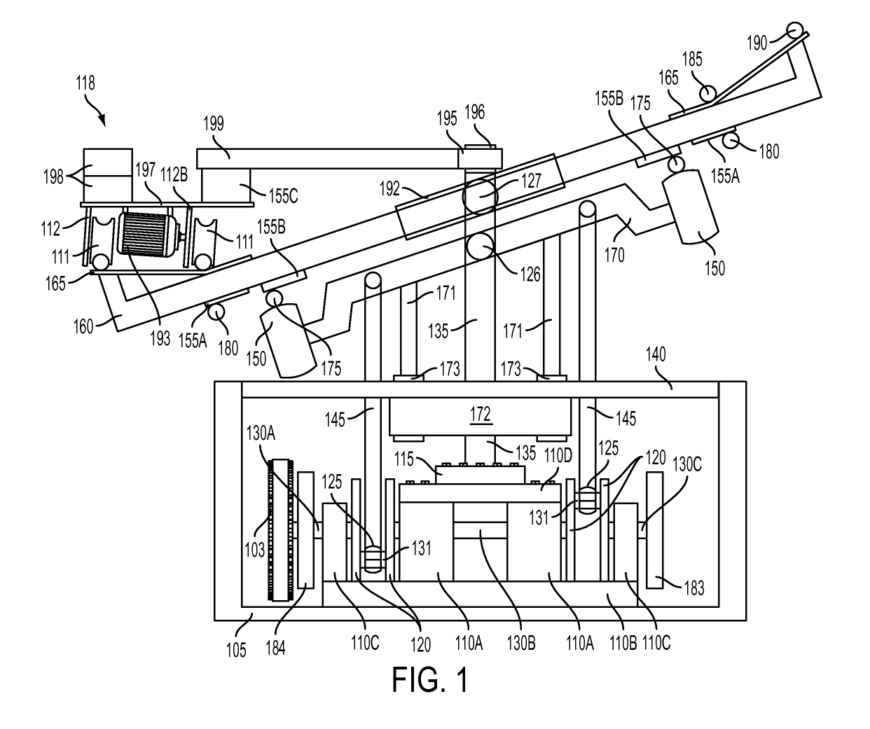

With reference to FIG. 1, a mechanical advantage machine incorporating an elliptical track is depicted. Coupled to the elliptical track may be a cart support arm 199 that may be coupled to a motor 193. In one embodiment, the cart support arm 199 can be composed of steel and can be approximately six feet in length, but the composition and the length of the cart support arm 199 is not limited so long as weight 198 with the coupled cart support arm 199 can travel along the circumference of the elliptical track. The cart support arm 199 can be coupled to a wheel hub 195, which can be coupled to at least one bolt 196. The bolt 196 can be attached to a support strut 135. The wheel hub 195, the bolt 196, and the support strut 135 can be composed of any material, for instance metal, such as steel or any other weight bearing material, including composites. The cart support arm 199 can also be coupled to a support plate 155C. The support plate 155C can be composed of metal, such as steel, and is configured in such a way to provide support to the cart support arm 199. The support plate 155C can be of varying size and weight; in an embodiment, the support plate 155C is approximately three feet by about three feet and about three hundred and fifty pounds.

A motor 193 can be coupled to a weight support 197. The weight support 197 can be approximately flat, made of metal, such as steel, and can support a weight 198. The motor 193 can drive a weight 198 and the coupled cart support arm 199 around an elliptical track. In other words, a mobile weight 198 can be powered by a mounted electric motor 193. The type of motor 193 is not limited as long as the motor 193 has the capacity to power the weight 198 coupled to the cart support arm 199 along the circumference of the track. In one embodiment, the selected motor 193 is five horsepower. The mass of the weight 198 is not limited, but in one embodiment it is four thousand pounds. The weight 198 in one embodiment is composed of steel, but can be made from any material. In an embodiment, the motor 193 can be coupled to the weight support 197 via bolting; the support plate 155C and the weight 198 can be attached to the weight support 197 by bolts; and the cart support arm 199 can be attached to the support plate 155C by also using bolts, a hinge, and/or welded. The specific bolts (also called screws, nails, and pins) are not specifically defined, but can be of any type, which securely attach each part to the other component. Of note, a cart 118 can include but is not limited to the motor 193, the weight support 197, the weight 198, the support plate 155C, the cart support arm 199, the wheel hub 195, at least one wheel 111, and wheel supports 112. Of further note, the motor 193 can be fastened or held in place by additional structure as necessary. Of even further note, in one embodiment, there can be three wheels 111. Of yet even further note, there can be multiple carts 118. Each cart 118 can be coupled to the other by a rod (not shown) via a u-joint, which can allow each cart to move as approximately independently. The rod can be made of steel and can be rigid. Each cart 118 can have a separate motor 193 or no motor 193 at all as long as at least one cart 118 has a motor 193 capable of operating the cart 118 including the weight 198. In another embodiment, the cart 118 can have no wheels 111, but instead can include at least one bearing or at least one chain or any method to support the movement of the cart 118. For instance, in an embodiment, a magnetic levitation (maglev) system using any maglev technology now known or later developed, including but not limited to electromagnetic suspension, electrodynamics suspension, and magnetodynamic suspension, can be used to move a weight 198 with or without a cart 118. In other words, the mobile weight 198 can be powered by magnetic levitation.

The track can be composed of an upper inner ring 185 and an upper outer ring 190, which can be coupled to a top ring support 165. The track, formed by the metal rings 185, 190, is approximately circular in shape, but can also be elliptical or any shape in which the cart 118 can travel. The cart 118 can travel along the rings 185, 190 on wheels 111. Each wheel 111 can be coupled to at least one wheel support 112 that can be coupled to the weight support 197. The wheel support 112 can be made of metal, including steel. Each wheel 111 can also be made of metal, including steel and aluminum, as well as plastic or any material that is capable of supporting the cart 118 with the weight 198. Each wheel 111 can also be coated with an additional material, such as polyurethane, to assist in reducing noise. Of note, each wheel 111 can be made from a different material.

The movement of the cart 118 around the circumference of the track causes the elliptical track to pivot which in turn causes the movement of at least one actuation rod 145 that rotates at least one cam 120 generating energy (power). In other words, the movement of the mobile weight 198 about the circumference of the track causes a portion of the elliptical track below the mobile weight 198 to move downwardly in response to the mobile weight 198 while concurrently an opposite portion of the track defined by the vertex moves upwardly, a repeated downward and upward movement of the track causing the actuation rod to move which in turn causes the cam 120 to rotate. Of note, a fulcrum point 127 disposed at a vertex of the circumference of the elliptical track enables a spherical bearing disposed at the fulcrum point 127 to pivot during the movement of the mobile weight 198.

The top ring support 165 can be coupled to a bottom ring support 160, both made of metal. Of note, the bottom ring support 160 can be composed of separate metal pieces that can be coupled together through any process, including bolts and/or welding. Coupled to the bottom ring support 160 are optional support plates 155A, 155B; each provide support for the outer lower ring (lower outer ring) 180 and the inner lower ring (lower inner ring) 175, respectively. The outer lower ring 180 can additionally be supported by the support base 105. In other words, as the elliptical track pivots in response to the movement of the cart 118, the outer lower ring 180 may rest on the support base 105. In an embodiment, the support base 105 is constructed to support the elliptical track. The support base 105, in an embodiment, can be four feet six and seven sixty fourth inches in height from the base of the support place to its high point.

The movement of the cart 118 can also cause the movement of the lower inner ring 175 and at least one power transfer ball 150 attached to a support assembly 170. Of note, the support assembly 170 can be made of two support plates coupled together with at least one bolt. The movement of the power transfer ball 150 causes the support assembly 170, or more specifically, a fixed bearing 126, to move in an approximately up and down manner, which causes at least one actuation rod 145 to move. Each power transfer ball 150 can rotate, can slide back and forth on its shaft, and can move up and down with the support assembly 170 and, in one embodiment, is made of aluminum. The actuation rod 145 can be coupled to a bearing 125, which can further be coupled to a cam 120, which turns in response to the approximately linear up and down motion of the actuation rod 145. Of note, the bearing 125 can be part of the actuation rod 145 or the bearing 125 can be a separate component that is couple to a shaft 131. The bearing 125 can reduce friction as the components move. A cam 120 can be coupled to approximately each end of the shaft 131. The shaft 131 can be made of any material now known or later developed, including but not limited to metal. In one instance, the actuation rod 145 via the shaft 131 can be coupled to at least one cam 120 at one end of the actuation rod 145 and coupled to the elliptical track at an opposite end of the actuation rod 145. The actuation rod 145 can be made of any material now known or later developed, including but not limited to metal, such as steel. In an embodiment, the distance between the point of attachment of the actuation rod 145 to the support assembly 170 and the center of the fixed bearing 126 is about two feet, and the distance between each point of attachment for each actuation rod 145 to the support assembly 170 is approximately four feet. In addition, the distance between the point of attachment of the actuation rod 145 to the support assembly 170 and the center point of the bearing 125 can be about four feet and three-sixteenth inches in an embodiment.

In an embodiment, there can be two sets of two cams 120, for a total of four cams 120. Each cam 120 can be coupled to a shaft 130A, 130C where each shaft 130A, 130C can further be coupled to an optional flywheel 184, 183. Further, one of the two shafts 130A, 130C, for instance shaft 130A, can be coupled to a rotor 103 and further connected to additional components in order to supply power to any device requiring such. Another shaft 130B can pass through support blocks 110A; shaft 130B can rotate upon the movement of a cam 120. Of note, in an embodiment, additional gears (not pictured) can be coupled to a shaft 130B to assist in the rotation of the shaft 130B. More specifically, a gear can be positioned vertically on the shaft 130B and meshed to a different gear, positioned horizontally, above the shaft 130B and below support block 110D. The horizontally positioned gear can be coupled to an axel (not pictured) inside the support strut 135 (running the length of the support strut 135) and coupled to a hub lock at the top of the support strut 135 proximal to the hub 195. In this way, as the cart 118 completes one rotation around the circumference of the track, the shaft 130B will also complete one rotation. Of further note, the gears can be of varying ratios: for instance, in an embodiment, a one to one ratio can exist; in another, any gear ratio can be used. Each flywheel 183, 184 can be of similar size and shape to each other, but are not required to be of similar size or shape. Of even further note, the power required to mobilize the weight 198 about the track is less than the power produced at the cam 120.

The weight unit 118 can rotate on a horizontal axis forcing the elliptical track to pivot on a fulcrum point 127 disposed at a vertex of the circumference of the elliptical track. A spherical bearing can coupled at the fulcrum point 127. The spherical bearing enables the elliptical track to pivot in any direction. The spherical bearing can be coupled to a support plate 192 that can be further coupled to the bottom ring support 160. In one embodiment, the spherical bearing can be encased in a steel casing; the steel ring is coupled to the support plates 192. The size (the dimensions) of the spherical bearing will vary depending on the size of the mechanical advantage device, but in one embodiment it is about twelve inches in diameter. The spherical bearing can be manufactured by any technique now known or later developed. A support plate 192 can be positioned on the top and bottom of the bottom ring support 160 to secure the spherical bearing. The spherical bearing can be coupled to the support strut 135. The support strut 135 can be fixed, i.e. it does not rotate, turn, or move. The support strut 135 can be attached to a wheel hub 195 on one end and to a strut support block or a strut support 115 at the other end. In one embodiment, the support strut 135 is fitted through the spherical bearing and into the strut support 115; thus, the support strut 135 may be threaded at either end or both as to enable it to be fixed in place. The dimensions of the support strut 135 are not specifically defined, but in an embodiment, the support strut 135 is about five feet long and has a circular cross section that is about six inches in diameter. The support strut 135 can also be coupled to at least one support beam 140. Optionally, coupled to the support assembly 170 can be at least one guide bar 171, which can be coupled to a guide bar support assembly 172 having at least one guide post 173. The guide bar 171 along with the guide bar assembly 172 and any guide post 173 can help ensure that the mechanical advantage drive operates smoothly. Specifically, the guide post 173 can add support for the support assembly 170 as well as assist in preventing left/right movement of the support assembly 170. Of note, the guide post 173 can contain at least one bearing to lessen the friction of the guide bar 171, which passes through the guide post 173. Additional support blocks 110A, 110B, 110C, 110D assist in distributing the weight of the elliptical track, the support strut 135 as well as the shafts 130A, 130B, 130C.

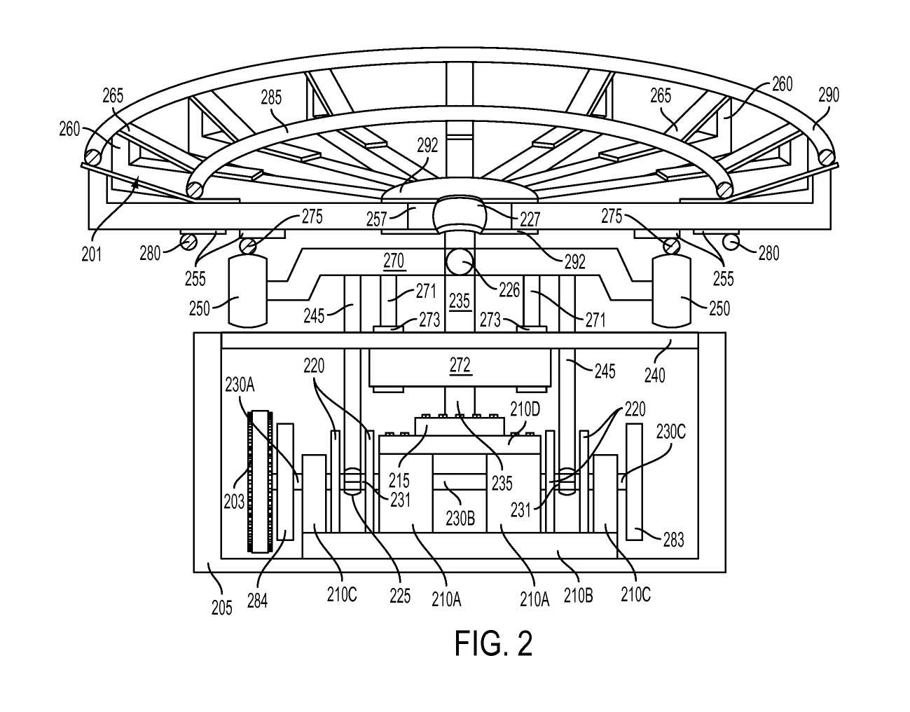

As a further illustration, FIG. 2 is a cut-away view of an embodiment of a mechanical advantage machine shown without a cart with an elliptical track 201—at a neutral tilt—coupled to a spherical bearing 227 in a casing 257 that is coupled to at least one support plate 292. Of note, the spherical bearing 227 can be coupled to a fulcrum point disposed at a vertex of the circumference of the track 201. The casing 257 can be made of steel. The elliptical track 201 is further coupled to a support strut 235, and the support strut 235 can be placed within the spherical bearing 227. The elliptical track 201 can be formed by an upper outer ring 290 and an upper inner ring 285 supported by a top ring support 265 and a bottom ring support 260. A lower outer ring or outer lower ring 280 and an inner lower ring or a lower inner ring 275, as well as support plates 255 can also be provided. During operation of the mechanical advantage machine, the lower inner ring 275 contacts one of the power transfer balls 250.

The power transfer balls 250 are attached to a support assembly 270. The support assembly 270 attaches to the support strut 235 through a fixed bearing 226. Also attached to the support assembly 270 can be at least one actuation rod 245. The support strut 235 can also optionally be coupled to at least one support beam 240, which can be disposed atop a guide bar support assembly 272 having at least one guide post 273. The guide post 273 can allow a guide bar 271 attached to the support assembly 270 to pass through it. The support beam 240 can be attached to the support strut 235 to provide support. The support strut 235 can be coupled to a strut support 215.

The strut support 215 is disposed atop a support block 210D. Support block 210D sits (rests) on additional support blocks 210A. Support blocks 210A along with support blocks 210C support shafts 230A, 230B, 230C and cams 220. Support blocks 210A, 210C are positioned on support block 210B. Each actuation rod 245 can be coupled to a bearing 225, two cams 220, and at least one shaft 231. Of note the shaft 231 is coupled to one cam 220 at about one end of the shaft 231 and to a different cam 220 on the approximate opposite end of the shaft 231. Optionally, in one embodiment, a cam 220 can be coupled to a flywheel 283, 284 via a shaft 230A, 230C. Each flywheel 283, 284 can be of similar size and shape to each other, but are not required to be of similar size, shape, or mass; for instance, one flywheel, for example flywheel 283 can be more heavily weighted then another flywheel 284. Of note, the flywheel 283, 284 can be coupled to a rotor 203. Of note, the layout or arrangement of the support blocks 210A, 210B, 210C, 210D do not have to be arranged in a particular layout, but are arranged in such a way to provide support for all shafts, including but not limited to shafts 230A, 230B, 230C and the support strut 235 as well as the power transfer system. Support block 210B can be coupled to a support base 205.

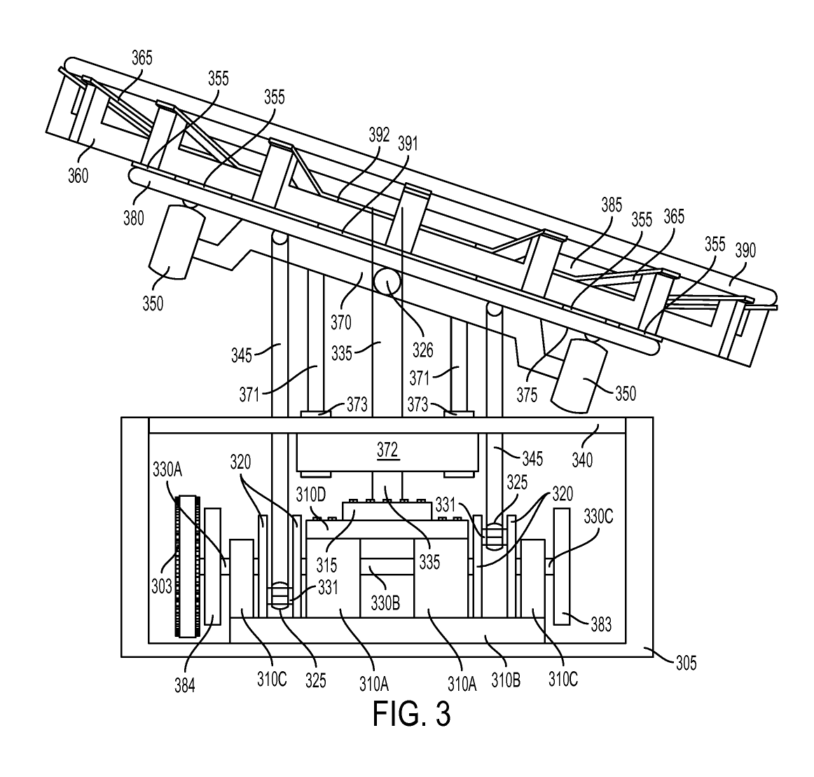

In further illustration, FIG. 3 is a view of a mechanical advantage machine with a tilted elliptical track and is shown without a cart. FIG. 3 can include an upper outer ring 390 that is coupled to a top ring support 365. The top ring support 365 can also be coupled to an upper inner ring 385. Coupled to the top ring support 365 is a bottom ring support 360. Attached to the bottom ring support 360 are support plates 355 which are connected to a lower outer ring 380 and a lower inner ring 375. A support plate 392 aids in supporting the bottom ring support 360 and a spherical bearing (not shown). Of note, the connecting plate 391 can connect the spherical bearing and the bottom ring support of the elliptical track. In an embodiment, the spherical bearing and the cart support arm are coupled through a support strut 335 via a wheel hub. Of note, the spherical bearing can be placed at a fulcrum point disposed at a vertex of a circumference of the elliptical track.

The support strut 335 is further coupled to a fixed bearing 326. The fixed bearing 326 is coupled to a support assembly 370, which moves (pivots) in an approximately vertical (up and down) motion in response to the movement of a power transfer ball 350 that is coupled to the support assembly 370. The support strut 335 is coupled to a strut support 315. In addition, at least one support beam 340 can provide additional support to the support strut 335. The support beam 340 can be disposed atop a guide bar support assembly 372. The guide bar support assembly 372 can include at least one guide post 373, which can allow a guide bar 371 coupled to the support assembly 270 to pass through. The strut support 315 can rest on top of a series of additional support blocks 310A, 310B, 310D, which are configured to support the elliptical track and the power transfer ball system. In addition to support blocks 310A, 310B, 310D, support blocks 310C can provide support and/or serve as an attachment point for any shafts, including but not limited to shafts 330A, 330B, and 330C as well as any cams 320. Each cam 320 can optionally be coupled to a flywheel 383, 384, where the flywheel 383, 384 can be further coupled to additional components, just as a gearing, including a rotor 303, to both increase and capture the energy generated by the machine. The cam 320 is also attached to a bearing 325, which is configured to receive one end of an actuation rod 345. The bearing 325 can be coupled to a shaft 331, where the shaft 331 is configured to receive a cam 320 on approximately each end. The actuation rod 345 can be attached to the support assembly 370 of the elliptical track in such a way, including via a pivot point, to ensure the actuation rod 345 moves in an approximately linear up and down motion as to more effectively rotate the cam 320. Support block 310B is disposed atop a support base 305. The support base 305 also serves as a stop; it prevents the elliptical track from tilting too much. In other words, during operation, the lower outer ring 380 is stopped from pivoting any further when it comes into contact with the support base 305.

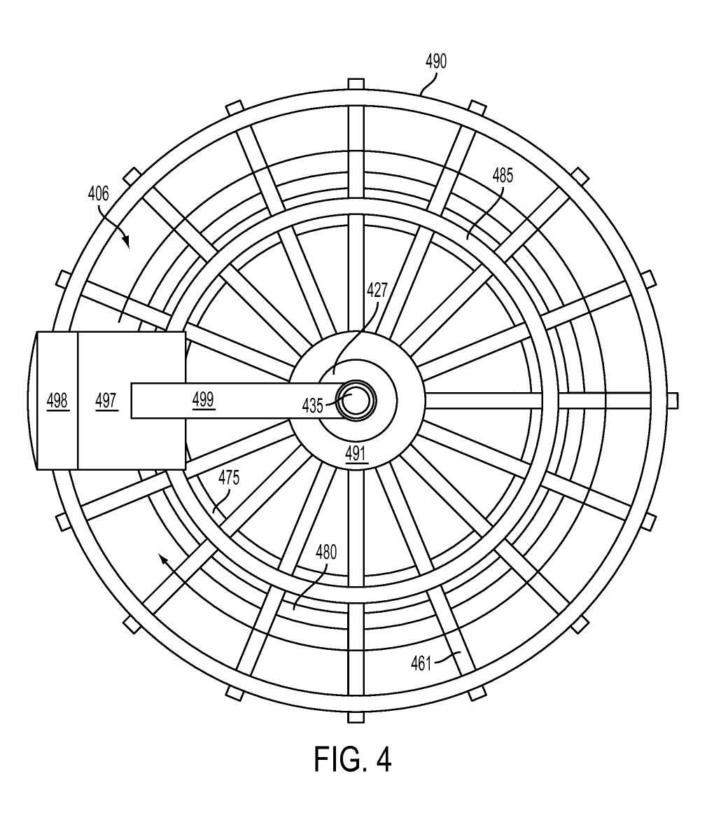

In further illustration, a plan view of a track 406 with a rotating weight 498 is shown in FIG. 4. Of note, the track 406 can be approximately elliptical in shape, approximately circular in shape, or any shape in which a weight 498 can travel. A weight 498 rests atop a weight support 497 that can be coupled to a cart support arm 499. The cart support arm 499 along with the weight 498 and weight support 497 are propelled around a track 406 by a motor (not shown) in the direction as shown in FIG. 4. Of note, the motor can move in either direction as determined by the desire of the operator. The cart support arm 499 rotates on a horizontal axis moving the weight 498 which in turn forces the track 406 to pivot. More specifically, power can be generated by mobilizing the weight 498 about a circumference of the track 406 comprising a fulcrum point disposed at a vertex of the circumference of the track, the mobilization pivots the track 406 at the fulcrum point in response to the weight 498 traversing the track 406, while at least one actuation rod coupled to at least one cam moves responsively to the mobilization, as one portion of the track 406 moves downwardly in response to the weight 498 passing above the one portion, while concurrently a portion of track 406 opposite the one portion across the fulcrum point moves upwardly, where the movement of the actuation rod causes the rotation of the cam. The track 406 is composed of an upper outer ring 490 and an upper inner ring 485, which are both coupled to ring support 461. The ring support 461 affixes the upper rings 490, 485 in place as well as provides support to a lower inner ring 475 and a lower outer ring 480. The ring support 461 is made of metal, such as steel, and can be composed of individual members that are fastened (bolted and/or welded) together. A connecting plate 491 connects the cart support arm 499 and a spherical bearing 427. Of note, the spherical bearing 427 can be attached at the fulcrum point disposed at the vertex of the circumference of the track 406. In addition, a support strut 435 is coupled to the cart support arm 499 via a wheel hub.

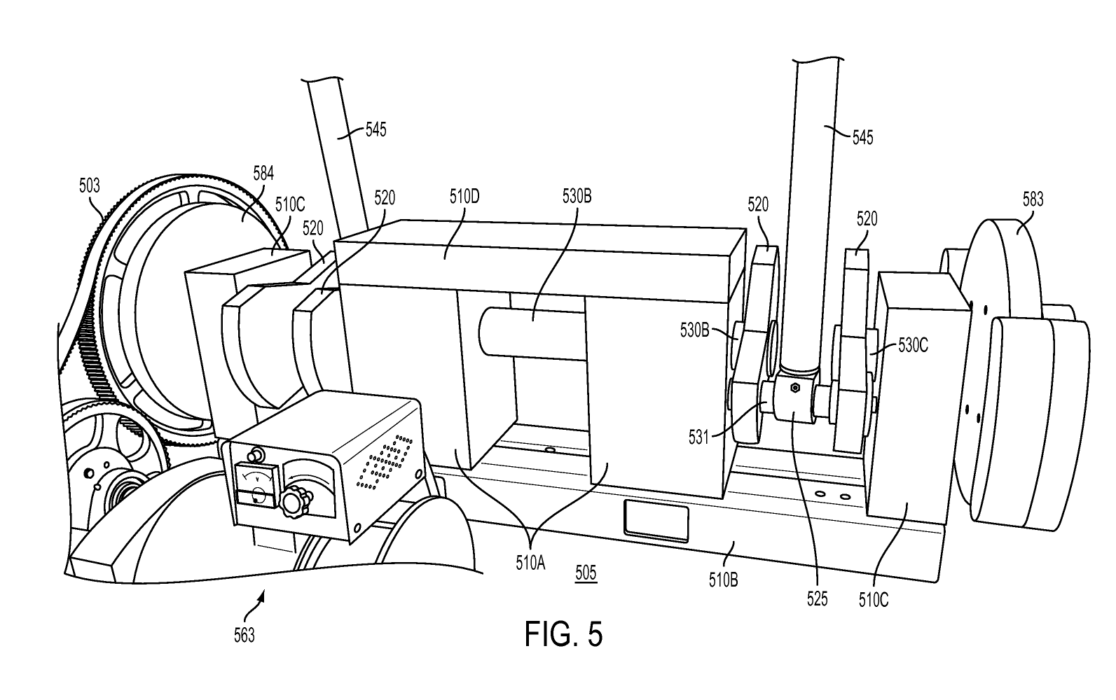

In further illustration, FIG. 5 shows an embodiment of a view of a power transfer system 563. The power transfer system 563 can be coupled to a support base 505. The power transfer system 563 may also be coupled to the support base 505 in a variety of different methods, including but not limited to welding, bolting, and resting. The power transfer system 563 can be largely composed of components made of metal, but may contain components manufactured from other materials as long as the power transfer system 563 can transfer power.

The power transfer system 563 can be composed of different support blocks, including support block 510B. Disposed atop support block 510B can be support blocks 510A, 510C. Coupled to one of the support blocks 510C via a shaft (not shown) can be a flywheel 584. Though this shaft is not shown is can be similar in size and shape as shaft 530C. The flywheel 584 is not limited to a specific size or mass, but may vary depending on the size of the mechanical advantage machine. In an embodiment, the flywheel 584 is approximately twenty-four inches in diameter. A bolt can secure the flywheel 584 to the shaft. The shaft is not defined by a specific size, but can be of a length as to couple a cam 520 to the flywheel 584, but in one instance the shaft is about five inches in diameter. In an embodiment, the shaft can also coupled the cam 520 and flywheel 584 to a rotor 503. The rotor 503 can further be connected to additional components, such as additional gearing, motors, etc. in order to supply power to any device requiring such. The shaft can be supported by support block 510C.

An additional shaft 530C can be coupled to an additional flywheel 583. Of note, the flywheel 583 can be of any size or weight; in one instance flywheel 583 can weigh more than flywheel 584. This additional shaft 530C can be of about similar size and shape as the shaft coupled to flywheel 584 and can also be supported by support block 510C. Shaft 530C along with the previously mentioned shaft can be coupled to a flywheel 583, 584 on approximately one end and a cam 520 on the opposite end. Of note, though multiple flywheels 583, 584 are illustrated in this embodiment, there can be a singular flywheel or no flywheels in the power transfer system 563.

An actuation rod 545 can contain a bearing 525 to allow a coupled shaft 531 to more easily rotate. Of note, the actuation rod 545 can be coupled to at least one cam 520 at one end via the shaft 531 and the track at an opposite end. The shaft 531 is not defined by a specific size, but in an embodiment, the shaft 531 can be of about eighteen inches in length with a diameter of about five inches. The actuation rod 545 can cause a cam 520 to turn as the actuation rod 545 moves in an approximate vertical elliptical motion. The size of the cams 520 used is not specifically defined, but in one embodiment the cam 520 can be made of steel and have a size of about twenty inches in diameter.

Another shaft 530B can be coupled to each support block 510A as well as a cam 520 on approximately each end of the shaft 530B. Shaft 530B can be about thirty-six inches in length and can be about five inches in diameter. An additional support block 510D rests atop support blocks 510A. Support block 510D can provide support for other components, such as a strut support (not shown).

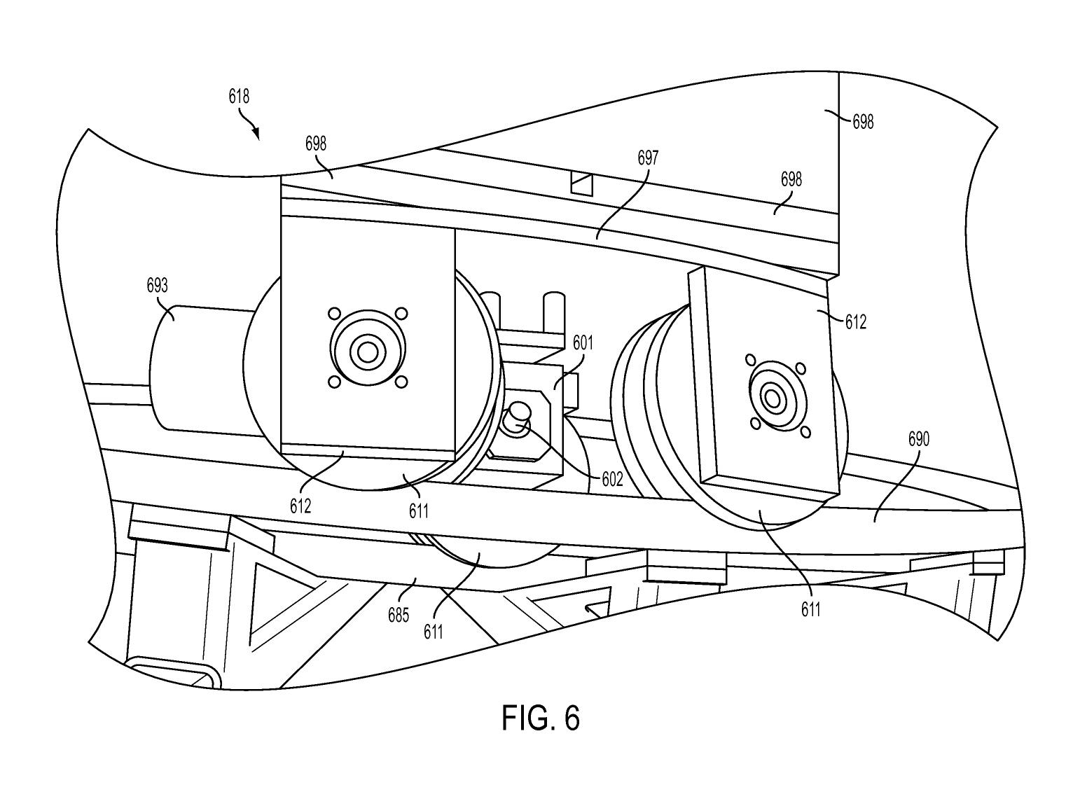

In further illustration, FIG. 6 is a view of a cart 618 in an embodiment of a mechanical advantage machine. In one embodiment, a cart 618 can have three wheels 611, where each wheel 611 can be coupled to a wheel support 612. One wheel 611 can travel along an inner ring 685 of a track while the other two wheels 611 can travel along the outer ring 690 of a track. Of note, each wheel 611 can be made from any type of metal, such as steel and aluminum, or any type material that can support the cart 618 and weight 698; each wheel does not need to be made from the same material. In addition, each wheel 611 can be coated in polyurethane. Each wheel support 612 can be coupled to weight support 697, which supports weight 698. Coupled to the wheel 611 traveling along the inner ring 685 can be a shaft 602 coupled to a gear box 601. The gear box 601 can be further coupled to a motor 693. In one instance, the gear box 601 can be a ten to one gear box 601. Of note, there can be multiple carts 618 traveling around the track. Of further note, the cart 618 can include additional structure as necessary, including but not limited bolts and screws.

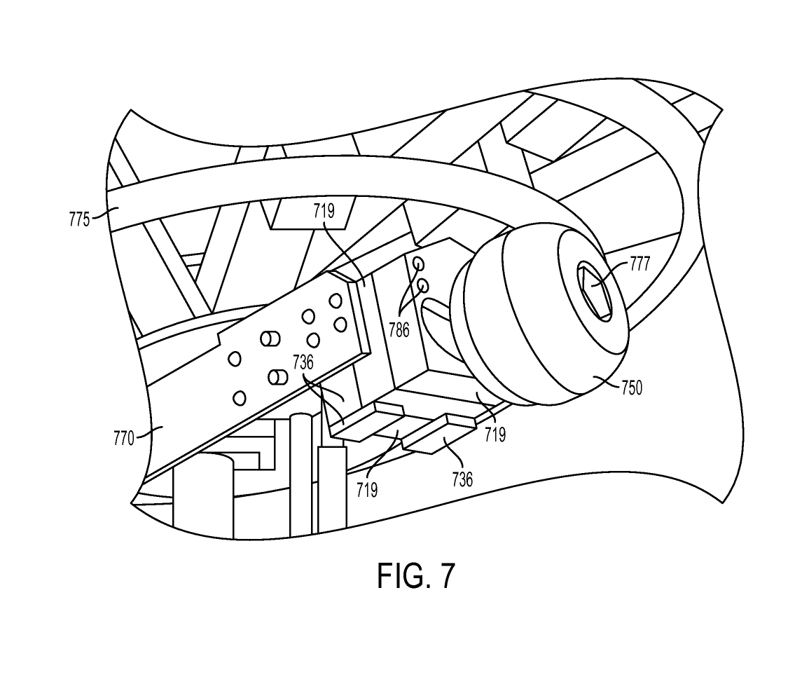

In even further illustration, FIG. 7 shows a power transfer ball assembly in one embodiment. The power transfer ball assembly can include the power transfer ball 750 coupled to a shaft (not shown) that passes through the power transfer ball 750. The shaft can be connected to the power transfer ball 750 via a bolt 777. The shaft can be configured to fit through at least one aperture in at least one plate 719. In one embodiment, there can be three plates 719; each with an aperture configured to allow the shaft to fit through. In an embodiment, the shaft can be twenty inches long and four inches in diameter; each plate 719 can be about sixteen and one-quarter inches by about sixteen inches. The thickness of each plate 719 can vary; one plate 719 can be approximately four inches thick and another plate 719 can be two inches thick. A plate 719 can include a shelf-like cutout to allow the power transfer ball 750 to slide back and forth as well as up and down on at least one bearing as the support assembly 770 moves. In one embodiment, there can be two bearings. In addition, the power transfer ball 750 can rotate three hundred sixty degrees on the shaft. Of note, there can be a power transfer ball assembly coupled to each end of the support assembly 770. A bracket 736 can be configured to fit and support at least one plate 719. Each plate 719 can be secured to the other plate 719 by at least one bolt 786. In one instance, six bolts 786 can be used. In addition, the plates 719 can be secured to the bracket 736 by any means, including welding and fastening. Of note, the power transfer ball 750 can be made of any material, including but not limited to plastic, composites, metal, for instance, aluminum, and the other components, including the bracket 786, plates 719, shaft 744, and bolts 786, can also be made of any material including but not limited to plastic, composites, metal, such as steel. Of note, as the cart travels along the track causing the movement of the elliptical track, the power transfer ball 750 moves staying in approximately constant contact with the lower inner ring 775. Of further note, in an embodiment, there can be two power transfer ball assemblies; one coupled to approximately each end of the support assembly 770.

Of note most parts referenced are manufactured using standard machining practices now known or later developed. In addition, though most parts are manufactured from metal, typically steel, parts (components) can be made from any material now known or later developed, including but limited to plastic and composites, that enables the machine to operate as described herein. Of further note, all parts can be coupled together using any technique capable of coupling parts together given each part's composition now known or later developed, including but not limited to, welding and bolting. Of even further note, additional components, such as but not limited to bearings, additional fasteners, support pieces, may also be used.

As will be appreciated by one skilled in the art, aspects of the present invention may be embodied as a system, method, or apparatus. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows.

I claim:

1. A mechanical advantage machine comprising:
an elliptical track;
a mobile weight traversing a circumference of the elliptical track;
a fulcrum point disposed at a vertex of the circumference of the elliptical track;
at least one actuation rod coupled to at least one cam at one end of the rod and coupled to the elliptical track at an opposite end of the rod,
wherein the traversal of the mobile weight about the circumference of the elliptical track causes a portion of the elliptical track below the mobile weight to move downwardly in response to the mobile weight while concurrently an opposite portion of the elliptical track defined by the vertex moves upwardly, a repeated downward and upward movement of the elliptical track causing the actuation rod to move which in turn causes the cam to rotate.

2. The mechanical advantage machine of claim 1, wherein the mobile weight is powered by a mounted electric motor.

3. The mechanical advantage machine of claim 1, wherein the mobile weight is powered by magnetic levitation.

4. A method for power generation comprising:
mobilizing a weight about a circumference of an elliptical track comprising a fulcrum point disposed at a vertex of the circumference of the elliptical track, the mobilization pivoting the elliptical track at the fulcrum point in response to the weight traversing the elliptical track, while at least one actuation rod coupled to at least one cam at one end and coupled to the elliptical track as an opposite end of the actuation rod moves responsively to the mobilization as one portion of the elliptical track moves downwardly in response to the weight passing above the one portion, while concurrently a portion of elliptical track opposite the one portion across the fulcrum point moves upwardly, where the movement of the actuation rod causes the rotation of the cam.

5. The method of claim 4, wherein the weight is powered by a mounted electric motor.

6. The method of claim 4, wherein the weight is powered by magnetic levitation.
